(19) United States
(12) Patent Application Publication
(10) Pub. No.: US 2020/0004839 A1
(43) Pub. Date: Jan. 2, 2020

(54) DOWNLOAD MANAGEMENT

(71) Applicant: MICROSOFT TECHNOLOGY LICENSING, LLC, Redmond, WA (US)

(72) Inventor: Aniket Krishnat NARAVANEKAR, Sammamish, WA (US)

(21) Appl. No.: 16/023,734

(22) Filed: Jun. 29, 2018

(51) Int. Cl. G06F 17/30; H04L 29/08; G06F 15/18

(52) U.S. Cl. CPC G06F 17/30085; H04L 67/34; G06F 15/18; G06F 17/30126; G06F 17/30117

(57) ABSTRACT

In a computing device, an indication is received that a content item is to be downloaded to a destination storage location. When the download of the content item is associated with a download policy, the associated download policy is applied to the download of the content item. A volatility indication for the download of the content item is determined. The content item is downloaded to the destination storage location. The downloaded content item is associated with a volatility property in accordance with the associated download policy or the volatility indication.

### BACKGROUND

Applications such as browsers may be used to download data from a remote source to the local device where the browser is running. For example, a user browsing to a banking website may download a bank statement, or a user browsing to a transportation website may download a bus schedule. An operating system typically defines a download location such as a download folder. The browser may default to the download folder and save all downloaded files to the download folder. The browser may also prompt the user to select a folder for saving downloaded content.

### SUMMARY

Files that are downloaded and saved in the download folder are typically left in the download folder or other folder designated by the user, even long after the files have been used or accessed. Such downloaded files may even remain in the download folder for months or years, and sometimes for the life of the device. Once a file is downloaded, the browser that was used to initiate the download typically has no further interactions or management of the downloaded files. Similarly, the operating system may not automatically perform any management of the download folder or its contents.

From a user perspective, the user often only views a file at the time of download, and typically does not view or access the file thereafter. As a result, over time the storage space consumed by the download folder may grow significantly, especially with the download of large media files and installation files.

Some operating systems may include the download folder during disk cleanup scans. However, the operating system typically only prompts the user as to whether the contents of the download folder should be deleted. The user may not be aware of what data is in the download folder, and being reticent about losing an important file, will often decline the proposed cleanup of the download folder. Some operating systems may provide an option to delete all files that have not been edited for a defined period of time such as 30 days. However, this is often not a useful indicator as to whether a user may want to keep a file. For example, some PDF or JPG files may not ever be edited but the user may nevertheless want to keep files that have not been edited (e.g., a PDF of a bank statement). All of these practices encourage the continued bloating of the download folder.

In various embodiments, systems and methods are described to address the shortcomings described above. In one embodiment, items such as files and other data that are downloaded may be associated with a designation that indicates how the downloaded item is to be stored and/or discarded. For example, when a download is initiated, a prompt may be provided to receive input from the user as to the volatility and storage properties of the downloaded item. For example, when a user selects a file to download via a browser, a prompt is typically rendered that provides a status of the download. In conjunction with providing the status of the download, the prompt may further request input indicating whether the downloaded item should be stored indefinitely (until explicitly deleted), stored for a predefined time period, stored for a time period defined by the user, stored only for the current action, or other actions as further detailed herein. In various embodiments, the user selection may be made at the time of download, or during setup, or by administrators, to name a few.

As used herein, the term “volatile file” may refer to a file that has a limited time period after which the file will be deleted or otherwise made inaccessible. By providing more management and configuration settings for items downloaded to the download folder, storage capacity on the computing device can be more efficiently utilized, inadvertent data loss can be avoided, and user information that is downloaded can be more securely persisted and discarded. For example, sensitive content may be left on a computer for indeterminate periods of time, which may place the sensitive content in an unnecessarily vulnerable position. For example, if a user were to download their bank statement, the “statement.pdf” will be placed in the downloads folder. If the user does not take the explicit action of deleting the bank statement, the file will remain in the download folder indefinitely.

In some embodiments, the user may be enabled to select a value from a plurality of values that indicate how long a downloaded file is to be stored until the file is deleted. In another embodiment, an enterprise may allow download settings for a device to be configured by an administrator. For example, the administrator may configure all downloaded information to be deleted after a selected time period.

Many embodiments disclosed herein implement ways to configure disposition settings for data content that is downloaded. Disposition of data content generally refers to the destruction of a content item, typically a content item that has expired or otherwise does not need to be retained. Such content is typically in electronic form, and the disposal method may include deletion from the file system as well as active erasure of the electronic data from its storage location or transfer of the electronic data from its storage location. The appropriate method of disposal may be determined by the confidential or sensitive nature of the content, or other factors.

In some embodiments, the computing device may automatically determine the disposition configuration of a downloaded file, based on the type of file and past disposition actions that have been selected for similar files. In one example, based on past actions, an executable file may be deleted after seven days, while document files (e.g., .doc, .xls, etc.) may configured to remain in the download folder until the user explicitly deletes the document. In one embodiment, the computing device may employ machine learning to determine the disposition of a downloaded file.

In one embodiment, information from multiple computing devices may be collected and analyzed. Based on the analysis, user data may be collected regarding various content downloads, and disposition actions may be determined. For example, if a particular executable file has been downloaded many times by multiple users, then such a file may be configured to automatically delete after seven days. Since the file is observed to be downloaded many times, it may be assumed that the downloaded file is readily available (e.g., the downloaded file may be a newly released software update).

Content downloaded to the download folder on one device may need to be re-downloaded on other devices if the user wishes to access the downloaded content. In some embodiments, if the user indicates that a downloaded file is important (or other designation), the downloaded file can further be saved remotely (i.e., copied to the cloud). The copy on the cloud not only serves as a backup of the file, but the file's placement to the cloud allows the file to be accessible by the user on other devices.

In one embodiment, the file may be moved from the download folder to the cloud and removed from the local device (i.e., “dehydrated”). As used herein, the term “dehydrated file” may refer to a data file that is stored on a local drive of a client device in a format that makes the data file visible to a user in a file-browser GUI while at least some content data of the data file is absent from the local drive. For example, a dehydrated file may be a relatively small file that is stored locally on a client device to represent a hydrated counterpart file that is stored in a cloud database. An example dehydrated file may include a thumbnail image (e.g., a reduced-size visual representation of file content data) and metadata that identifies the name of the file and points to its hydrated counterpart in the cloud. As used herein, the term “hydrated file” may refer to a data file for which both metadata and file content data are stored on a local drive of a client device so that the data file can be opened locally without fetching the file content data from a cloud database.

In some embodiments, all files in the download folder may have a copy added to the cloud. This may allow the contents of the download folder to by synchronized and available to other devices that are provided access to the download folder.

In some embodiments, the contents of the download folder and information for the downloaded files may be made available via a user interface, allowing the user to view the content of the download folder and their disposition settings.

In some embodiments, the techniques described herein may be applied to downloaded items that are not sent or saved to the downloads folder. For example, in some cases the user may select another location for saving downloaded content. Additionally, some applications may not explicitly download content, but may nevertheless download content in order to execute requested actions. For example, an email attachment may be downloaded in order for the user to view the content. The downloaded attachment, even when the attachment is not explicitly selected for downloading, may nevertheless be downloaded and saved locally. In many cases, the user may not be aware that content has been downloaded and saved locally. The techniques described herein may be applied to such content.

The present disclosure may thus alleviate some of the issues related to bloating of used disk space as files are downloaded and left on the computer, even when the files are no longer needed. Even when the user attempts to clean up the download folder, the sheer volume of downloaded files may inhibit the user from deleting unwanted data, due to the time it would take to carefully review each data item and the fear of accidentally deleting a file that the user may later need. It may thus be easier to allow the bloated download folder to persist, further exacerbating the problem.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is an example user interface in accordance with the present disclosure;

FIG. 2A is an example computing environment in accordance with the present disclosure;

FIG. 2B is an example computing environment in accordance with the present disclosure;

FIG. 3 is a flowchart depicting an example operational procedure in accordance with the present disclosure;

FIG. 4 is a flowchart depicting an example operational procedure in accordance with the present disclosure;

FIG. 5 is a flowchart depicting an example operational procedure in accordance with the present disclosure; and

FIG. 6 illustrates an example data structure in accordance with the present disclosure.

### DETAILED DESCRIPTION

The following Detailed Description describes systems and methods that enable a computing device to alleviate issues pertaining to files that are downloaded to a computing device. Typically, when an application such as a web browser downloads a file, a local copy of the file is saved on a folder on the computing device, such as the download folder. The downloaded file typically remains stored on the device in the download folder until the user takes an explicit action to delete the file. In some cases, the downloaded files may remain on the computing device indefinitely. In some embodiments disclosed herein, downloaded files may be configured to be deleted after a specified time period, which may also be referred to as time-bombing. Additionally or alternatively, the downloaded file may be uploaded to a remote location such as a cloud-based storage housed in a data center.

The download folder is a typical feature of many operating systems and may be the default location where downloaded content is stored. Over time, the amount of content and therefore the size of the download folder can grow to a significant size, often consuming a sizable portion of a user's allocated storage space. Unfortunately, the content is often stale as many downloaded files are no longer needed, obsolete, or have been copied elsewhere. For example, the user may have consumed the content (for example, a training video) and the user may no longer need a local copy on the device.

Another problem is that sensitive and private content may be left behind for indefinite periods of time. For example, if a user were to download a bank statement “statement.pdf,” the “statement.pdf” file will be placed in the download folder. If the user does not take the explicit action of deleting this file, the file will remain in the download folder indefinitely, long after the user has viewed the information.

Finally, another problem is that content that is downloaded on one device will need to be re-downloaded on other devices if the user wishes to access the content from other devices, thus increasing the scope of the problem as multiple copies of data may be downloaded and remain indefinitely on multiple devices.

In some cases, the user may consider manually deleting content when the content is no longer required. For example, the user may delete files after they are used, or files may be deleted periodically. In some cases, an operating system or third party tool may be used that is configured to periodically remove all files that are older than a specified time. Finally, the user may manually move or copy content that is needed by other devices to a private cloud service such as One Drive. However, many of these solutions require explicit actions by the user to effect the deletion or removal of the content. If no action is taken, then the download folder will likely continue to grow.

In one embodiment, at the time of the download of a content item, a decision may be indicated and saved as to whether the content to be downloaded will be volatile or whether the content will be allowed to persist. Volatile refers to a file that is configured to be deleted from storage after a specified period of time or some other condition. Otherwise, the file may remain in persisted storage unless explicitly moved or deleted. The decision may be captured as a volatility setting that may be associated with the downloaded content. By addressing the issues noted above by determining whether the content to be downloaded will be volatile or whether the content will be allowed to persist, improvements may be made to operation and function of a computing device by reducing the amount of stale and unused data is stored on the computing device and providing additional unallocated storage space. Furthermore, the improvements described herein provide greater security by removing sensitive information that is no longer needed.

In one embodiment, the browser or other application may provide a prompt or other interface that allows the user to indicate whether a file or other content that is to be downloaded should be treated as volatile or persisted. In some embodiments, a default setting may be implemented where all downloaded content may be indicated as volatile (or persisted).

In some embodiments, historical and other data may be used to determine whether a downloaded content item should be indicated as volatile or persisted. For example, data from a user's past choices regarding volatility of files may be used to intelligently determine volatility settings for a content item. For example, if the user historically chooses to persist all PDF files, for example through explicit user action, similar content items may be indicated to be persisted indefinitely.

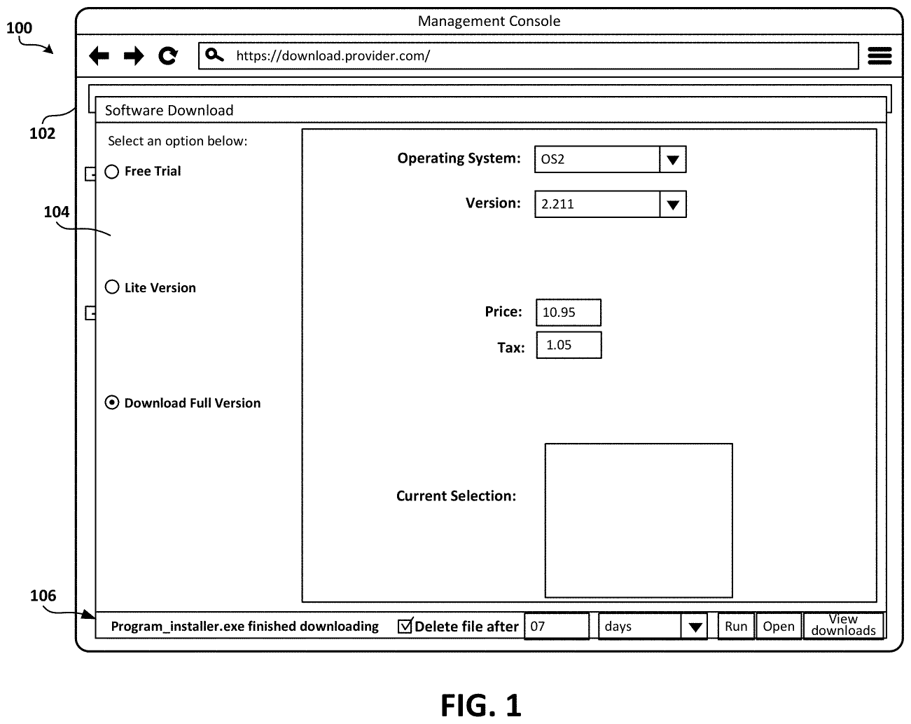

In one embodiment, a download notification may be provided as illustrated in FIG. 1. Illustrated is an example of a notification 106 provided in conjunction with a download site 104 as rendered in a browser window 102 of a display 100. The notification 106 may include, for example, an indication of the name of the content item that is to be downloaded. The notification 106 may also include an option to delete the content item after a selectable time period.

When a content item is indicated as volatile, and optionally indicated to be deleted after a specified time period, the file may be associated with metadata that indicates its volatility status and time-to-live information. In some embodiments, a purge task may execute periodically, continuously, or based on some trigger. The purge task may be configured to purge volatile files that have exceeded their indicated time-to-live. For example, a downloaded file may be indicated as volatile with its lifetime set to expire after the current user session. In this example, when the user logs off the current session, a trigger may be generated that will cause the purge task to purge the file.

In another example, a downloaded file may be indicated as volatile with a time-to-live set to 7 days. The purge task may be triggered once a day and delete files older than 7 days. In some embodiments, specified scenarios such as OS servicing events may trigger the purge tasks.

In some embodiments, when the content item is not marked as volatile, the storage location of the content item may be defaulted to a remote storage such as a cloud location associated with the user. For example, after either a specified time period has passed, or after some other criteria such as a low free space threshold, the content item may be moved to a cloud-based download folder. The moving of a file from a device to a cloud-based location may be referred to as “dehydration,” while retaining the file's apparent availability on the local device. In this way, the content item may be preserved for future retrieval, while freeing up space on the local device.

In one embodiment, a default volatility configuration may be associated with downloaded content. For example, each content item may be defaulted to be volatile or persisted. If the default is to be volatile, then a default time-to-live may also be associated with each content item. Additionally, a default time-to-live for each content item may be determined based on the type of the content item (e.g., document, graphic, executable, etc.).

In one embodiment, if the computing device is a managed device due to the device being domain joined or master data management (MDM) enabled, then an administrator may be allowed to make volatility selections. The administrator may set download policies that govern the volatility and other properties of the downloaded content. As used herein, download policies may refer to volatility properties that are consistent with selections by the administrator, as well as those that may be determined as default volatility conditions or otherwise determined automatically.

In some embodiments, one or more configuration options may be provided when a content item is to be downloaded. For example, when an item is selected for download via a browser, a pop-up menu may be rendered that allows a user to select a volatility configuration for the content item. The menu may also allow the user to select the time-to-live for the content item if the item is to be volatile, or the menu may allow the user to select the time before the content item is to be dehydrated.

In some embodiments, user interfaces may be rendered to allow a user to review volatility options for content items in the download folder. For example, the user may be able to navigate to the shell or file explorer to view the status of volatile files. Additionally, the user may be provided the option to update the time-to-live or mark the content item to persist indefinitely. The user may also be able to manually delete downloaded files.

In one embodiment, the computing device may employ machine learning to determine the disposition of a downloaded file. In some embodiments, an analytics engine may be provided on the device and/or off the device that can implement various techniques for classifying content. For example, a machine learning engine can be implemented that executes a probabilistic classifier such as a naive Bayes classifier to determine content types and factors that may influence the disposition of downloaded content. The machine learning engine may, for example, implement a pattern classification system to identify relevant content types and patterns of disposition. In some embodiments, supervised learning may be incorporated where administrators of the computing device may classify observations made from a number of devices and a number of content types. The administrators or other analysis service may learn which observations are alike and assign metadata to identify these observations.

In some embodiments, an algorithm, such as a feature subset selection algorithm or an induction algorithm, may be implemented to define groupings or categories. Probabilistic approaches may also be incorporated. One or more estimation methods may be incorporated, such as a parametric classification technique. In various embodiments, the data storage and analysis service may employ a combination of probabilistic and heuristic methods to guide and narrow the data that are analyzed.

Thus in various embodiments, an application such as a browser that is configured to initiate downloads may further be configured to manage the marking of content for volatility, time limits for deletion and/or dehydration, and other policies. In some embodiments, the browser may initiate deletions and/or dehydrating content.

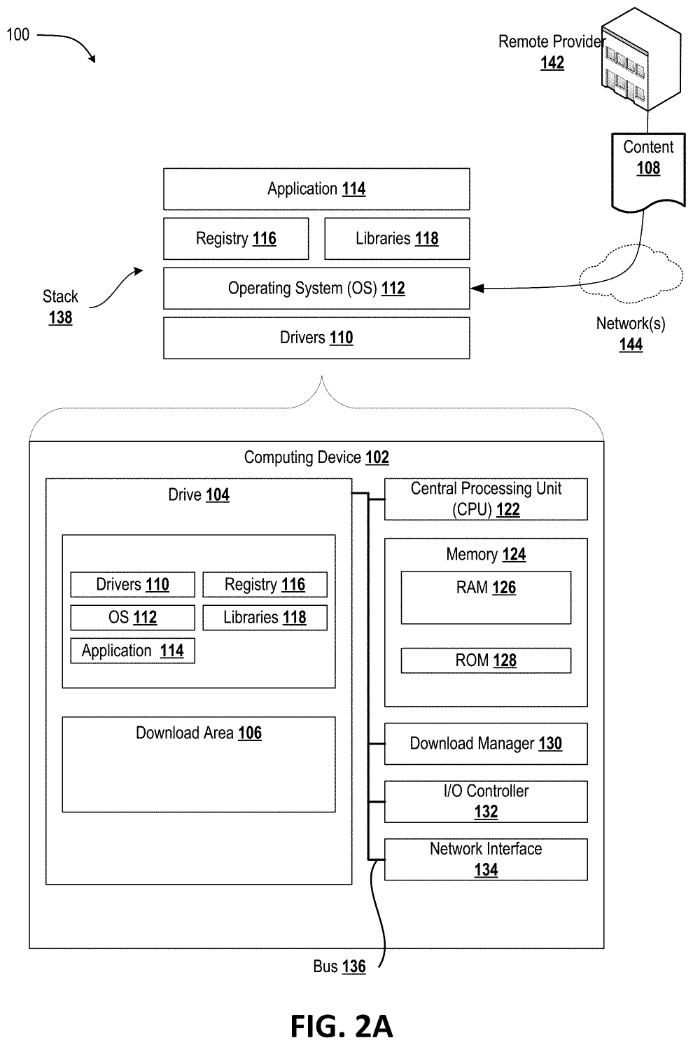

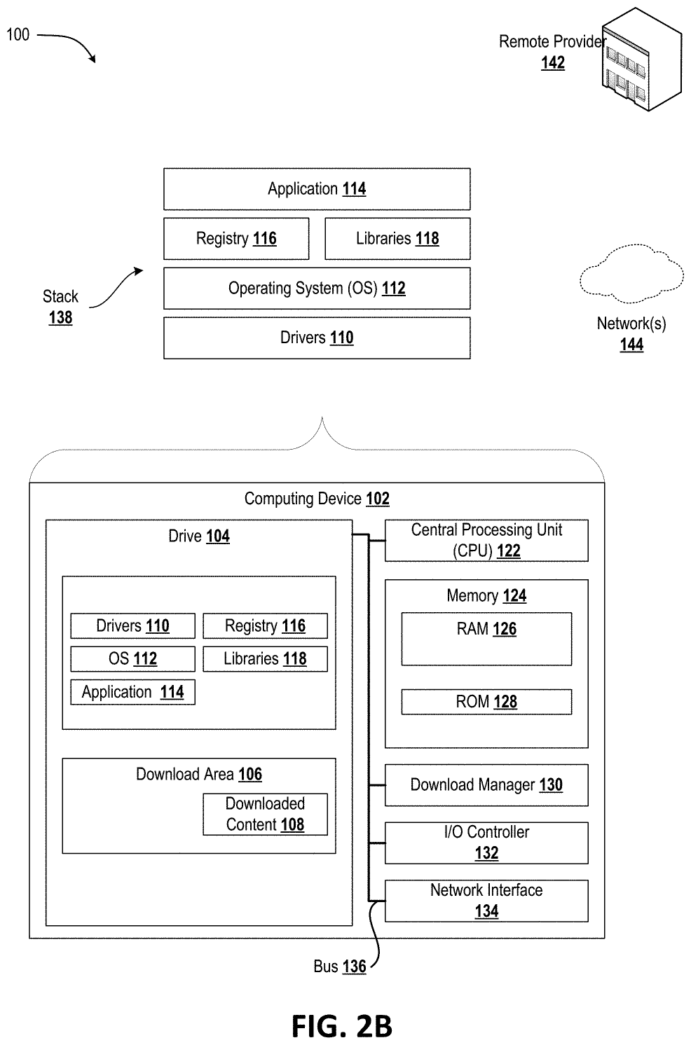

Turning to FIG. 2A, illustrated is an example computing system 100 for downloading content 108. Example system components include, but are not limited to, drivers 110, an operating system (OS) 112, an application 114 such as a browser, a registry 116, and/or libraries 118. The example computing system 100 enables the computing device 102 to execute any aspects of the software components and/or functionality presented herein. Furthermore, the example computing architecture 100 illustrated in FIG. 2A shows an example architecture for a personal computer (e.g., a laptop and/or desktop computer), a tablet computer, a smart phone, a server computer, a server rack, a network of server computers, or any other types of computing devices suitable for implementing the functionality described herein.

As illustrated in FIG. 2A, the computing device 102 may include one or more drive(s) 104 (hereinafter referred to as the “drive”) having computer-readable media that provides nonvolatile storage for the computing device 102. Example drives include, but are not limited to, SATA-type solid-state hard drives, SATA-type hard disks, PATA-type solid-state hard drives, PATA-type hard disks, and/or any other drive-type suitable for providing non-volatile computer-readable media to a computing device. The drive 104 may include multiple partitions for logically separating one or more system components and/or data objects.

In some embodiments, the drive 104 stores drivers 110 and an operating system (OS) 112 to enable a boot manager 130 to initiate the drivers 110 and to load the OS 112 into a memory 124. In the illustrated example, the memory 124 includes a random-access memory (“RAM”) 126 and a read-only memory (“ROM”) 128. As further illustrated, the computing device 102 includes a central processing unit (“CPU”) 122 that is connected, via a bus 136, to the drive 104, the memory 124, and the download manager 130. In some embodiments, the bus 136 further connects an input/output (I/O) controller 132 and/or a network interface 134. The download manager 130 may be configured to receive or determine volatility properties of downloaded content 108 in accordance with the present disclosure.

Drive 104 may also include a download area 106 that may be designated for storing data content 108.

It can be appreciated that the system components described herein (e.g., the drivers 110, the OS 112, and/or the application 114) may, when loaded into the CPU 122 and executed, transform the CPU 122 and the overall computing device 102 from a general-purpose computing system into a special-purpose computing system customized to facilitate the functionality presented herein. The CPU 122 may be constructed from any number of transistors or other discrete circuit elements, which may individually or collectively assume any number of states. More specifically, the CPU 122 may operate as a finite-state machine, in response to executable instructions contained within the software modules disclosed herein. These computer-executable instructions may transform the CPU 122 by specifying how the CPU 122 transitions between states, thereby transforming the transistors or other discrete hardware elements constituting the CPU 122.

The drive 104 and associated computer-readable media provide non-volatile storage for the computing device 102. Although the description of computer-readable media contained herein refers to a mass storage device, such as a solid-state drive and/or a hard disk, it should be appreciated by those skilled in the art that computer-readable media can be any available non-transitory computer storage media or communication media that can be accessed by a computing architecture such as, for example, the computing architecture 100. Communication media includes computer-readable instructions, data structures, and/or program modules. By way of example, and not limitation, communication media includes wired media such as a wired network or direct-wired connection. Combinations of the any of the above are also included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 102. For purposes of the claims, the phrase “computer storage medium,” “computer-readable storage medium,” and variations thereof, does not include waves, signals, and/or other transitory and/or intangible communication media, per se. A boot manager (now shown) may access the OS 112 from the drive 104 (or a partition thereof) and may load the OS 112 into the memory 124 for runtime execution by the computing device 102 (e.g., by invoking an OS boot loader).

The I/O controller 132 may receive and process input from a number of other devices, including a keyboard, mouse, or electronic stylus (not shown in FIG. 2A). Similarly, the I/O controller 132 may provide output to a display screen, a printer, or other type of output device (also not shown in FIG. 2A). The network interface 134 may enable the computing device 102 to connect to one or more network(s) 144 such as a local area network (LAN), a wide area network (WAN), a wireless local area network (WLAN), or any other suitable network for passing information between the computing device 102 and a remote resource 142.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims. It also should be understood that the illustrated methods can end at any time and need not be performed in their entireties. Some or all operations of the methods, and/or substantially equivalent operations, can be performed by execution of computer-executable instructions included on a computer-storage media, as defined herein.

FIG. 2B illustrated the systems and components illustrated in FIG. 2A, and also illustrates downloaded content 108 stored in download area 106. Additional download areas may be created in drive 104, or in other storage areas.

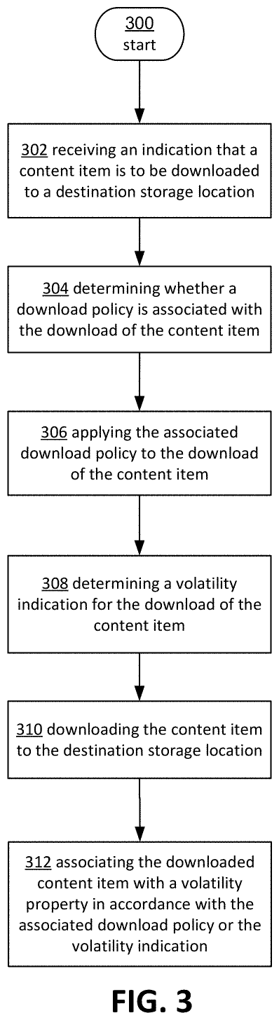

Referring to FIG. 3, illustrated is an example operational procedure in accordance with the present disclosure. Referring to FIG. 3, Operation 300 starts the procedure, and operation 302 illustrates receiving, from an application executing on the computing device, an indication that a content item is to be downloaded to a destination storage location.

Operation 302 may be followed by Operation 304. Operation 304 illustrates determining whether a download policy is associated with the download of the content item. The download policy may be determined based on selections provided by an administrator, determined by a download manager as further described herein, or other information pertaining to download properties associated with the content item. Operation 304 may be followed by Operation 306. Operation 306 illustrates when the download of the content item is associated with a download policy, applying the associated download policy to the download of the content item. Operation 306 may be followed by Operation 308. Operation 308 illustrates determining a volatility indication for the download of the content item. The volatility indication may be provided via user input or otherwise determined in accordance with the present disclosure. The volatility indication may also be based on the associated download policy. Operation 308 may be followed by Operation 310. Operation 310 illustrates downloading the content item to the destination storage location.

Operation 310 may be followed by operation 312. Operation 312 illustrates associating the downloaded content item with a volatility property in accordance with the associated download policy or the volatility indication. The volatility property may include the time period such as a time-to-live, the action to be taken when the time period elapses, and the location where the downloaded content is to be moved (if appropriate).

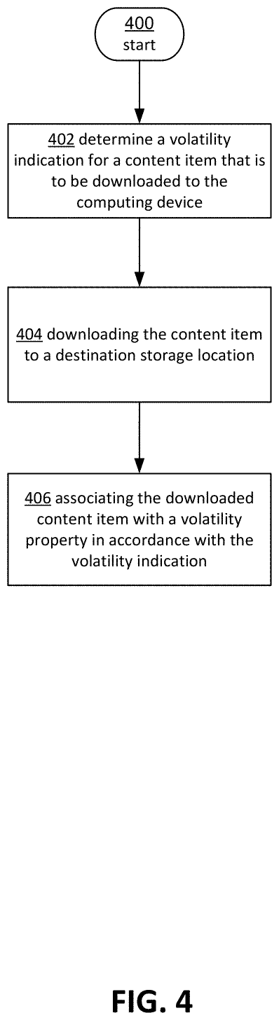

Referring to FIG. 4, illustrated is an example operational procedure in accordance with the present disclosure. Referring to FIG. 4, Operation 400 illustrates start of the operation, and operation 402 illustrates determine a volatility indication for a content item that is to be downloaded to the computing device.

Operation 402 may be followed by Operation 404. Operation 404 illustrates downloading the content item to a destination storage location.

Operation 404 may further be followed by Operation 406. Operation 406 illustrates associating the downloaded content item with a volatility property in accordance with the volatility indication.

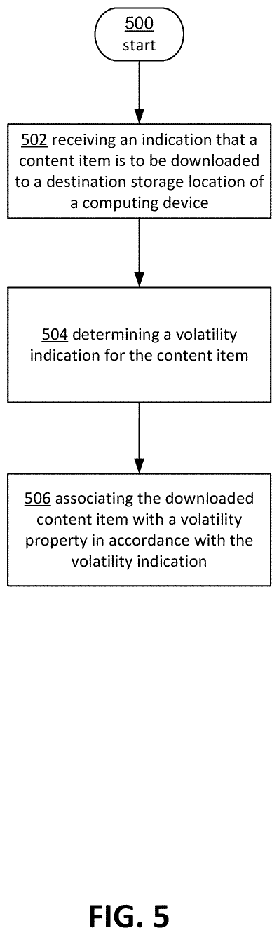

Referring to FIG. 5, illustrated is an example operational procedure in accordance with the present disclosure. Referring to FIG. 5, Operation 500 begins the procedure and operation 502 illustrates receiving an indication that a content item is to be downloaded to a destination storage location of a computing device. Operation 502 may be followed by operation 504. Operation 504 illustrates determining a volatility indication for the content item.

Operation 504 may be followed by Operation 506. Operation 506 illustrates associating the downloaded content item with a volatility property in accordance with the volatility indication.

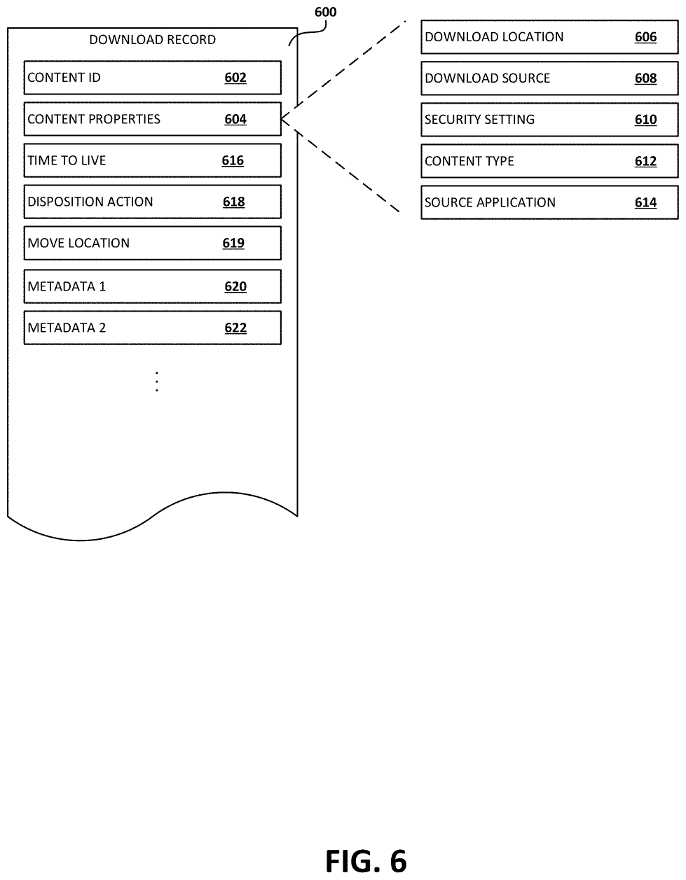

FIG. 6 is a data structure diagram showing a number of data elements stored in a download record 600 storing metadata for a downloaded content item. It will be appreciated by one skilled in the art that the data structure shown in the figure may represent a data file, a database table, an object stored in a computer storage, a programmatic structure or any other data container commonly known in the art. Each data element included in the data structure may represent one or more fields in a data file, one or more columns of a database table, one or more attributes of an object, one or more variables of a programmatic structure or any other unit of data of a data structure commonly known in the art.

Each download record 600 may contain a content ID 602 identifying the content item for which the download record 600 is created. According to one embodiment, each download record 600 may also contain a content properties field 604 identifying various information pertaining to the downloaded content item. In one example, the content properties field 604 may include download location 606 indicating where the downloaded content item is stored locally, download source 608 indicating information as to from what source the downloaded content item was downloaded, security setting 610 indicating information pertaining to the security or sensitivity of the downloaded content item, content type 612 indicating the type of file or other information identifying the type of content, source application 614 indicating the application that may be used to open the item, and the like. The download record 600 may also contain time to live 616 indicating, for example, the time period that is associated with the downloaded content item before further action is taken.

The download record 600 may also contain information regarding disposition action 618 indicating whether the downloaded content item is to be deleted, moved, or other action, after the time to live 616 has expired. The download record 600 may contain a move location field 616 indicating, for example, where the downloaded content item is to be moved if the disposition action 618 indicates that the downloaded content item is to be moved. The download record 600 may further contain information regarding one or more metadata 620 and 622. It will be appreciated that the download record 600 may contain additional data elements beyond those shown in FIG. 6 and described above that are utilized in conjunction with reserve storage areas.

The disclosure presented herein may be considered in view of the following clauses.

Example Clause A, a computer-implemented method for managing data on a computing device, the method comprising:
receiving, from an application executing on the computing device, an indication that a content item is to be downloaded to a destination storage location;
determining whether a download policy is associated with the download of the content item;
when the download of the content item is associated with a download policy, applying the associated download policy to the download of the content item;
determining a volatility indication for the download of the content item;
downloading the content item to the destination storage location; and
associating the downloaded content item with a volatility property in accordance with the associated download policy or the volatility indication.

Example Clause B, the computer-implemented method of Example Clause A, wherein the application is a browser application.

Example Clause C, the computer-implemented method of any one of Example Clauses A through B, wherein the download policy is established by an administrator of the computer device.

Example Clause D, the computer-implemented method of any one of Example Clauses A through C, wherein the destination storage location is a download folder.

Example Clause E, the computer-implemented method of any one of Example Clauses A through D, wherein the volatility indication is a time period after with the content item is to be deleted.

Example Clause F, the computer-implemented method of any one of Example Clauses A through E, wherein the volatility indication is a time period after with the content item is to be dehydrated.

Example Clause G, the computer-implemented method of any one of Example Clauses A through F, wherein the volatility indication is a time period after with the content item is to be deleted and dehydrated.

Example Clause H, the computer-implemented method of any one of Example Clauses A through G, further comprising deleting the content item in accordance with the associated download policy or the volatility indication.

Example Clause I, the computer-implemented method of any one of Example Clauses A through H, wherein the volatility indication comprises a time period and action to be performed on the content item after the time period has elapsed.

Example Clause J, the computer-implemented method of any one of Example Clauses A through I, wherein the volatility indication is determined via a rendered prompt.

Example Clause K, the computer-implemented method of any one of Example Clauses A through J, wherein the volatility indication is determined based on input received via a rendered prompt.

Example Clause L, the computer-implemented method of any one of Example Clauses A through K, wherein the volatility indication is determined by a learning system.

Example Clause M, the computer-implemented method of any one of Example Clauses A through L, wherein the volatility indication is determined based at least in part on previous volatility indications.

Example Clause N, the computer-implemented method of any one of Example Clauses A through M, wherein the volatility indication is determined based at least in part on data indicative of downloads of the content item by other users.

Example Clause O, a computing device comprising:
one or more processors;
a memory in communication with the one or more processors, the memory having computer-readable instructions stored thereupon which, when executed by the one or more processors, cause the computing device to:
determine a volatility indication for a content item that is to be downloaded to the computing device;
downloading the content item to a destination storage location; and
associating the downloaded content item with a volatility property in accordance with the volatility indication.

Example Clause P, the computing device of Example Clause O, wherein the volatility indication is a default volatility indication.

Example Clause Q, the computing device of any one of Example Clauses O through P, wherein the volatility indication is determined based at least in part on data indicative of previous volatility indications for similar content items.

Example Clause R, the computing device of any one of Example Clause O through Q, wherein the volatility indication is determined based at least in part on data indicative of data indicative of volatility indications for similar content items by a plurality of users.

Example Clause S, the computing device of any one of Example Clauses O through R, wherein the volatility indication is determined based at least in part on a machine learning function trained with data indicative of volatility indications for similar content items.

Example Clause T, a computer-implemented method comprising:
receiving an indication that a content item is to be downloaded to a destination storage location of a computing device;
determining a volatility indication for the content item; and
associating the downloaded content item with a volatility property in accordance with the volatility indication.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A computer-implemented method for managing data on a computing device, the method comprising:
receiving, from an application executing on the computing device, an indication that a content item is to be downloaded to a destination storage location on the computing device;
determining whether a download policy is associated with the download of the content item;
when the download of the content item is associated with a download policy, applying the associated download policy to the download of the content item;
determining a volatility indication for the download of the content item;
downloading the content item to the destination storage location; and
associating the downloaded content item with a volatility property in accordance with one or more of the associated download policy or the volatility indication.

2. The computer-implemented method of claim 1, wherein the application is a browser application.

3. The computer-implemented method of claim 1, wherein the download policy is established by an administrator of the computer device.

4. The computer-implemented method of claim 1, wherein the destination storage location is a download folder.

5. The computer-implemented method of claim 1, wherein the volatility indication is a time period after with the content item is to be deleted.

6. The computer-implemented method of claim 1, wherein the volatility indication is a time period after with the content item is to be dehydrated.

7. The computer-implemented method of claim 1, wherein the volatility indication is a time period after with the content item is to be deleted and dehydrated.

8. The computer-implemented method of claim 1, further comprising deleting the content item in accordance with the associated download policy or the volatility indication.

9. The computer-implemented method of claim 1, wherein the volatility indication comprises a time period and action to be performed on the content item after the time period has elapsed.

10. The computer-implemented method of claim 1, wherein the volatility indication is determined via a rendered prompt.

11. The computer-implemented method of claim 1, wherein the volatility indication is determined based on input received via a rendered prompt.

12. The computer-implemented method of claim 1, wherein the volatility indication is determined by a learning system.

13. The computer-implemented method of claim 1, wherein the volatility indication is determined based at least in part on previous volatility indications.

14. The computer-implemented method of claim 1, wherein the volatility indication is determined based at least in part on data indicative of downloads of the content item by other users.

15. A computing device comprising:
one or more processors;
a memory in communication with the one or more processors, the memory having computer-readable instructions stored thereupon which, when executed by the one or more processors, cause the computing device to:
determine a volatility indication for a content item that is to be downloaded to the computing device;
downloading the content item to a destination storage location; and
associating the downloaded content item with a volatility property in accordance with the volatility indication.

16. The computing device of claim 15, wherein the volatility indication is a default volatility indication.

17. The computing device of claim 15, wherein the volatility indication is determined based at least in part on data indicative of previous volatility indications for similar content items.

18. The computing device of claim 15, wherein the volatility indication is determined based at least in part on data indicative of data indicative of volatility indications for similar content items by a plurality of users.

19. The computing device of claim 15, wherein the volatility indication is determined based at least in part on a machine learning function trained with data indicative of volatility indications for similar content items.

20. A computer-implemented method comprising:
receiving an indication that a content item is to be downloaded to a destination storage location of a computing device;
determining a volatility indication for the content item; and
associating the downloaded content item with a volatility property in accordance with the volatility indication.
